(19) United States
(12) Patent Application Publication
(10) Pub. No.: US 2023/0267337 A1
(43) Pub. Date: Aug. 24, 2023

(54) CONDITIONAL NOISE LAYERS FOR GENERATING ADVERSARIAL EXAMPLES

(71) Applicant: Protopia AI, Inc., Austin, TX (US)

(72) Inventors: Hadi Esmaeilzadeh, Austin, TX (US); Anwesa Choudhuri, Austin, TX (US)

(21) Appl. No.: 18/114,165

(22) Filed: Feb. 24, 2023

Related U.S. Application Data
(60) Provisional application No. 63/313,661, filed on Feb. 24, 2022.

(51) Int. Cl. G06N 3/094; G06N 3/047

(52) U.S. Cl. CPC G06N 3/094; G06N 3/047

(57) ABSTRACT

Provided is a process including: obtaining, with a computer system, a data set having labeled members with labels designating corresponding members as belonging to corresponding classes; training, with the computer system, a machine learning model having deterministic layers and a parallel set of conditional layers each corresponding to a different class among the corresponding classes, wherein training includes adjusting parameters of the machine learning model according to an objective function that is differentiable; and storing, with the computer system, the trained machine learning model in memory.

### CROSS-REFERENCE TO RELATED APPLICATIONS

This application claims the benefit of U.S. Provisional Pat. App. 63/313,661, titled OBFUSCATED TRAINING AND INFERENCE WITH STOCHASTIC CONDITIONAL NOISE LAYERS, filed 24 Feb. 2022, the entire content of which is hereby incorporated by reference.

### BACKGROUND

Machine learning models, including neural networks, have become the backbone of intelligent services and smart devices, such as smart security cameras, voice assistants, predictive text, anti-spam email services, etc. The machine learning models may operate by processing input data from data sources, like cameras, microphones, unstructured text, and outputting classifications, inferences, predictions, control signals, and the like.

### SUMMARY

The following is a non-exhaustive listing of some aspects of the present techniques. These and other aspects are described in the following disclosure.

Some aspects include application of conditional noise layers in a machine learning model.

Some aspects include training of conditional noise layers in a machine learning model.

Some aspects include determination of a measure of robustness to adversarial attack based on conditional noise layers in a machine learning model.

Some aspects include determination of a universal adversarial example based on conditional noise layers in a machine learning model.

Some aspects include a tangible, non-transitory, machine-readable medium storing instructions that when executed by a data processing apparatus cause the data processing apparatus to perform operations including the above-mentioned application.

Some aspects include a system, including: one or more processors; and memory storing instructions that when executed by the processors cause the processors to effectuate operations of the above-mentioned application.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 depicts an example machine learning model using conditional noise layer, in accordance with some embodiments;

FIG. 2 depicts an example measure of robustness determined using conditional noise layers, in accordance with some embodiments.

FIG. 3 illustrates an exemplary method for conditional noise layer training, according to some embodiments;

FIG. 4 shows an example computing system that uses a stochastic noise layer in a machine learning model, in accordance with some embodiments;

FIG. 5 shows an example machine-learning model that may use one or more vulnerability stochastic layer; and

FIG. 6 shows an example computing system that may be used in accordance with some embodiments.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

To mitigate the problems described herein, the inventors had to both invent solutions and, in some cases just as importantly, recognize problems overlooked (or not yet foreseen) by others in the fields of machine learning and computer science. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Machine learning algorithms (e.g., machine learning models) may consume data (e.g., labeled data, unlabeled data, etc.) during training and, after training (or during active training) at runtime, including in some cases where sample data may be used as training data and may alter parameters of the algorithm. Machine learning algorithms may at least periodically be trained on new data (e.g., training data), which may include sensitive data that parties would like to keep confidential. For instance, in some cases, such as federated learning use cases, an untrained or partially trained model may be distributed to computing devices with access to data to be used for training, and then those distributed computing devices may report back updates to the model parameters (e.g., the model parameters learned based on distributed data) or execute the trained model locally on novel data, including without reporting model parameters back. In some cases, during training, the model may be on a different network, computing device, virtual address space, or protection ring of an operating system relative to a data source. This may increase the attack surface for those seeking access to such data and lead to the exposure of the data, which may reveal proprietary information or lead to privacy violations. A single compromised computing device may expose the data upon which that computing device trains the model. Similar issues can arise in applications training a model on a single computing device. Machine-learning algorithms may be applied to distributed models using techniques described in U.S. patent application Ser. No. 17/865,273 filed 14 Jul. 2022, titled REMOTELY-MANAGED, DATA-SIDE DATA TRANSFORMATION, the contents of which are hereby incorporated by reference.

In some cases, a trained, untrained, partially-trained, or continually-trained model may be subject to adversarial attacks based on received training data and sample data. In an adversarial attach, an entity (e.g., a malicious entity) may seek to provide input data to a machine learning model which may incorrectly identify, classify, make an inference based on, etc.

To mitigate these issues, some embodiments use conditional noise layers, which may be stochastic conditional noise layers (also referred to as conditional stochastic layers), together with trained models and in the models during training to obfuscate training data. In some embodiments, the un-obfuscated training data may not be accessible to the model (e.g., from the process training the model). In some embodiments, a conditional noise layer (or selection layers which may make up one or more conditional noise layer) may be selected during application of the model to training data, sample data (or otherwise processing out-of-training-sample inputs), etc. by selection of one or more conditional layers (or selection layers) responsive to data labels. In some embodiments, selection layers may be combined with the stochastic noise layers to form label-specific conditional noise layers. In some embodiments, a portion (like less than 50%, 40%, 20%, 10%, 5%, 1%, or 0.1%) of the training data may be provided to the model in un-obfuscated form and used to train noise layers, which may then be used to obfuscate an additional portion of the training data. Regularization may be used to reduce bias from the un-obfuscated data being overrepresented.

Some embodiments may use conditional noise layers, which may be stochastic conditional noise layers, including selection layers, etc. together with trained (or partially-trained) models to determine a model's susceptibility to adversarial attack. In some embodiments, a model trained to output one of a set of outputs (e.g., one of a set of classifications, one of a set of inferences, etc.) may be used together with conditional noise layers for each of the set of outputs (e.g., set of labels applied as output). “Each” herein does not require a one-to-one relationship. For example, conditional noise layers may be used for some but not all of the set of output, a substantially identical conditional noise layer may be used for two non-identical outputs, etc. A conditional noise layer may be trained to determine the model's sensitivity to adversarial attack. In some embodiments, the conditional noise layer may be used to generate a set of training data with noise which the model may be expected to be correctly processed (e.g., a noisy data set). In some embodiments, the conditional noise layer may be used to generate a set of training data with noise which may be expected to be incorrectly processed (e.g., mislabel, tilted, etc.), which may be a an adversarial attack training data set. “Correctly processes” and “incorrectly processed” refer to misapplication of output, based on the label of the input before application of noise. As noise may be stochastic, including sampled for each application of noise or each generation of training data, “correctly” and “incorrectly” may be understood to apply to average, percentage, relative chances, etc. That is, a “correctly processed” set of noisy data may be correctly labeled 55% of the time, while an “incorrectly processed” set of adversarial attack training data may be incorrectly processed (e.g., by the model on which the conditional noise layer was trained) 50% of the time—including examples where ranges of accuracy overlap between the “correctly” processed and “incorrectly” processed data for some models.

In some embodiments, conditional noise layers may be trained on a model and used to measure a susceptibility of the model to an adversarial attack. In some embodiments, a conditional noise layer may be used to measure a susceptibility of the model to an adversarial attack focused on one or more outputs of a set of outputs (for example, labeling malicious email, such as spam, as normal email). In some embodiments, a magnitude of a conditional noise layer may be used as a measure of susceptibility. In some embodiments, a magnitude or standard deviation of a stochastic conditional noise layer (e.g., such as a stochastic noise layer sampled from a Gaussian distribution) may be used as a measure of susceptibility. In some embodiments, a difference between a magnitude of a conditional noise layer for a first condition (e.g., label) and a second condition may be used a measure of susceptibility. A measure of susceptibility may be a measure of robustness (or an inverse of a measure of robustness). Herein, any embodiment described in reference to a measure of susceptibility may also be applied to or used with a measure of robustness.

In some embodiments, the conditional noise layer may be used to generate training data which may be used to retrain the model, such as to increase robustness, where retraining includes incremental training, further training, training of a new model, etc. or any other appropriate training regime. For example, the conditional noise layer may be used to generate an adversarial attack training data set, which may be used to retrain the model, generate an adversarial patch, or otherwise improve the robustness of the model to adversarial attack.

In some embodiments, the conditional noise layers may be used to generate quasi-synthetic data (e.g., training data, sample data, testing data), such as by various application of stochastic noise, such as by methods described in.

In some embodiments, conditional noise layers may be used to generate universal adversarial examples. A “universal” adversarial example may be a condition (e.g., input, noise applied to an input, etc.) which causes misclassification by the model—such misclassification may be unidirectional, lead to classification no better than random guessing, etc. The universal adversarial example may be conditional—that is may be different for each condition (or expected output of the set of outputs). The universal adversarial example may cause a specific misclassification (e.g., of spam to normal email), may cause the model to not output an output (e.g., cause the model to not detect any input), etc. The universal adversarial example may provide information about the model's operation. For example, a sound outside of the normal range of human hearing may be used to cause an adversarial attack. In such an example, the identification of the universal adversarial example could be used to exclude such vulnerable wavelengths from sample data. The universal adversarial example may be used to find patterns that foil inferences. The universal adversarial example may be universal with respect to the space of inputs. The universal adversarial example may bias any outcome.

In some embodiments, labeled data may be used—for example, in the training data set. In some embodiments, some labeled data and some unlabeled data may be used—for example, in the training data set and in sample data. In some embodiments, self-supervised learning may be used to generate conditional noise layers. Self-supervised noise may be trained with techniques described in U.S. Pat. App. 63/420,287, titled SELF-SUPERVISED DATA OBFUSCATION and U.S. patent application Ser. No. 18/170,476 filed 16 Feb. 2023, titled OBFUSCATION OF ENCODED DATA WITH LIMITED SUPERVISION, the contents of which are hereby incorporated by reference.

In some embodiments, each label in the training set (e.g., class the model is configured to classify) may have a different corresponding conditional stochastic layer (or set of conditional stochastic layers which may be a subset of the layers, e.g., a convolutional layer, in a model that is otherwise deterministic), and in some cases, the objective function may remain differentiable when using these layers to facilitate computationally efficient training, e.g., with stochastic gradient descent. For instance, a set of image training data may include images of cats bearing the label “cat” and images of dogs bearing the label “dog,” and each class (cat or dog in this example) may have an associated set of class-specific noise mask that correlates to a class-specific conditional stochastic layer. Conditional noise may be convolutional noise, diffusion noise, attention noise, etc. The conditional noise may be additive, multiplicative, subtractive, divisional, etc. The conditional noise may be trained by backpropogation, gradient descent, or any other appropriate training method. Noise may be trained using techniques described in U.S. patent application Ser. No. 17/680,273 filed 24 Feb. 2022, titled STOCHASTIC NOISE LAYERS, the contents of which are hereby incorporated by reference. Conditional noise may be stochastic noise. Conditional noise may be deterministic noise.

In some embodiments, the conditional noise layers may serve to obfuscate sensitive data in each computing device during training, such that even if a process in the virtual memory space of the model itself is compromised, a threat actor would not necessarily have access to the obfuscated training data. Further, the technique may be tuned according to desired tradeoffs between accuracy and obfuscation.

Some embodiments augment otherwise deterministic neural networks with stochastic conditional noise layers. Examples with stochastic conditional noise layers include architectures in which the parameters of the layers (e.g., layer weights) are each a distribution (from which values are randomly (which includes pseudo-randomly) drawn to process a given input) instead of deterministic values. In some examples, the parameters of the layers (e.g., layer weights) are single values but when applied to their inputs, instead of generating the output of the layer, the output of the layer sets the parameters of a set of corresponding distributions that are sampled from to generate the output. In some cases, a plurality of parallel stochastic noise layers may output to a downstream conditional layer configured to select an output (e.g., one output, or apply weights to each in accordance with relevance to the classification) among the outputs of the upstream parallel stochastic noise layers. In some cases, the conditional layer may be trained to select, which may include binary selection or weighting, the outputs to effectuate correct classification, or to execute various other tasks targeted with machine learning or statistical inference. In some cases, for a given input, one parallel stochastic noise layer may be upweighted in one sub-region of the given input (like a collection of contiguous pixels in an image) while another parallel stochastic noise layer is down-weighted in the same sub-region, and then this relationship may be reversed in other sub-regions of the same given input.

In some embodiments, un-obfuscated data (which may be training data, sample data, etc. without applied noise) may be reside at a “trusted” computing device, process, container, virtual machine, OS protection ring, or sensor, and training may be performed on an “untrusted” computing device, process, container, virtual machine, or OS protection ring. The term “trust” in this example does not specify a state of mind, merely a designation of a boundary across which training data information flow from trusted source to untrusted destination is to be reduced with some embodiments of the present techniques. In some embodiments, a first subset of training data may be provided from the trusted source to the untrusted destination where model training occurs. The first subset may be used to train a set of conditional layers, each associated with a different classification (or other outcome of a machine learning model). The conditional layers may be provided to the trusted source, which may then use them (on training data having the corresponding label) to process the remaining second subset of the training data to output obfuscated training data, adversarial attack data, quasi-synthetic data, etc. In some embodiments, both the source and the model may be located on the same computing device or multiple “trusted” computing device. In some embodiments, some input data may be “trusted” while other input data may be treated as possibly containing an adversarial attack. The data may be obfuscated through the operation of the conditional noise layer, which may be stochastic, through random selection of distributions corresponding to model parameters, as discussed elsewhere herein. The data may be converted to adversarial attack training data by application of the conditional noise layer. The obfuscated training data (or adversarial attack training data) may be proved to the untrusted destination where model training continues on the obfuscated data or adversarial attack training data. In some embodiments, the untrusted computing device, process, container, virtual machine, or OS protection ring performing training may be prevented from accessing the un-obfuscated second subset of the training data, while the model may be trained to greater accuracy than that afforded by the first subset of the training data.

Some embodiments train a model to learn parameters of parametric noise distributions of inserted noise layers (e.g., conditional noise layers). The parametric noise distributions may be learned with the techniques described in U.S. patent application Ser. No. 17/458,165, filed 26 Aug. 2021, titled METHODS OF PROVIDING DATA PRIVACY FOR NEURAL NETWORK BASED INFERENCE, the contents of which are hereby incorporated by reference.

Some embodiments quantify a maximum (e.g., approximation or exact local or global maximum) perturbation (e.g., noise application) to a data set for generation of an data set input to a model that will allow the model to correctly label the input (e.g., satisfying a threshold metric for model performance). Some embodiments quantify a minimum (e.g., approximation or exact local or global minimum) perturbation (e.g., noise application) to a data set for generation of a data set input to a model that will prevent the model from correctly labeling the input. Some embodiments afford a technical solution to training conditional noise layers based optimization of parametric noise distributions (e.g., using a differentiable objective function (like a loss or fitness function), which is expected to render many use cases computationally feasible that might otherwise not be) implemented, in some cases, as a loss function. The outcome of training the conditional noise layers may be a loss expressed as a maximum perturbation that causes a minimum loss across a machine learning model. The outcome of training the conditional noise layers may be a loss expressed as the minimum perturbation that causes a maximum loss (or minimum loss above a threshold) across a machine learning model. The loss may be determined to find a maximum (or minimum) noise value that may be added (or otherwise combined, like with subtraction, multiplication, division, etc.) at one or more layer of the machine learning model to produce a data set that may be used to train a subsequent machine learning model. Some embodiments may produce an adversarial attack training data that may be applied to train various machine learning models, such as neural networks operating on image data, audio data, or text for natural language processing, or to generate a patch for a trained machine learning model.

Some embodiments measure training data sets susceptibility to noise addition. To this end, some embodiments determine a maximum (minimum) perturbation that may not cause mislabeling (correct labeling) by a machine learning model. In some embodiments, a tensor of random samples from a normal distribution (or one or more other distributions e.g., Gaussian, Laplace, binomial, or multinomial distributions) may be added to (or otherwise combined with) the input tensor X to determine a maximum variance value to the loss function of the neural network or autoencoder.

Data that goes through the compute during training may be completely exposed and all the features in each data record may be exposed to the compute device. This approach is orthogonal and complementary to federated learning, which is the prominent technique for privacy-aware training on machine learning models. In federated learning, multiple private machines work in isolation on their own data and calculate model updates without sharing their data with other parties that are involved. However, each machine's compute engine (e.g., GPU, CPU, TPU, etc.) may receives and see each data record in its entirety. Therefore, if the compute engine is compromised, the data records may be exposed, including to a malicious actor. This may be a different problem than what federated learning addresses, as federated learning may be concerned with not sharing data records across the machine that are collectively and globally performing the training. An exposure of single data records in each isolated machine while the local computation performed over the records may not be alleviated by federated learning, as the isolated machine sees the records. In some embodiments, a mechanism that aims to obfuscate and redact information from the data records before they go through the processing engine in each isolated machine is provided. Since the labels of the training data are known at the training time, the label information may be leveraged to create label-specific obfuscation for the model (e.g., the model undergoing the training process). That obfuscation may be provided by stochastic conditional noise layers. However, since during operation of the model (e.g., inference), labels are not available, the selection layers that combine label-specific stochastic conditional noise layers may be used. These layers (e.g., conditional layers, selection layers) may be used to obfuscate data during training and to provide information about the robustness of such training. These processes may be combined with federated learning or may be used without federated learning. Stochastic conditional noise layers may be built using trainable parameters that generate noise distribution, where the parameters depend on labels or categories present in a given training data set. The stochastic conditional noise layers may be combined using our proposed selection layers during model operation (e.g., inference), when the labels or categories of the data is unknown. The training procedure for the conditional noise layers may offers knobs that allow the trade off between accuracy and obfuscation to be controlled.

In some embodiments, conditional noise layers may be characterized based on their architecture. Any trainable network or layer(s) with trainable parameters may act as stochastic conditional noise layers. These may include convolutional layers, fully connected layers, recurrent layers like Long Short Term Memory (LSTM), Gated Recurrent Unit (GRU), transformer layers, additive layers, etc. In some embodiments, stochastic conditional convolutional noise layers may be used. In some embodiments, stochastic conditional fully connected noise layers may be used.

Convolution (in the context of neural networks) may be a linear mathematical operation where a kernel k slides across an input tensor x performing a linear operation at every location of the tensor x, thereby transforming x in a certain way. The output of this operation is a tensor hₖ which represents a feature (also called an activation). In a convolutional layer of a neural network, the input tensor x may be passed through a number of parameterized kernels, whose parameters are learnt during training through backpropagation. The activations hₖ from the respective kernels k may be stacked into channels to form the output h=[hₖ]. Equation 1 shows an example convolution operation.

$${h}_{k} [ m , n ] = ( x * k ) [ m , n ] = {\sum }_{i} {\sum }_{j} k [ i , j ] \times [ m + 1 , n + j ] \qquad ( 1 )$$

where in Eq. (1), [m, n] represents the spatial coordinates of the output tensor hₖ, and [i, j] represents the spatial coordinates of the kernel k.

Deep networks may be employed for tasks that involve categorizing objects into a specific category, such as from the training dataset. For example, object classification may involve determining whether a given image is of a cat or a dog. Object detection may involve the same, with the additional task of localizing the animal spatially. It may be useful to learn convolutional kernels specific to the category of objects (e.g., conditional kernels, conditional noise layers, etc.). In other words, convolutional layers can be conditioned on the category of object. This is shown, for example, by Equation 2 where represents the kernels specific to the category c in the training dataset.

$${h}_{{k}_{c}} [ m , n ] = ( x * {k}_{c} ) [ m , n ] = {\sum }_{i} {\sum }_{j} {k}_{c} [ i , j ] \times [ m + 1 , n + j ] \qquad ( 2 )$$

To introduce stochasticity, the output activations (such as h_{kc} in Eq. (2)), obtained as a result of the convolution operation between input x and kernels k_{c}, may be treated (e.g., act) as parameters of a probability distribution. Any probability distribution may be applicable—according to use case including Gaussian, Laplace, Binomial and Multinomial, etc. distributions. The kernels may convolve over an input to produce the parameters of a Gaussian distribution, mean (μ_{c}) and standard deviation (σ_{c}), conditioned on the image category c. In some embodiments, instead of following the usual practice of using h_{kc} (such as from Eq. (2)) directly as inputs to the next layers, the parameterized probability distribution may be sampled to find an h_{kc} and this sample may be used to determine an input to the next layer.

A fully connected layer may perform the inner-product between the input activation vector (x) and the trainable parameter vector W, such as as represented by Equation 3, below.

h=W·x (3)

The vector h may represent the output activation that propagates forward.

In some embodiments, it may be useful to learn weights W_{c} specific to the category of objects given in the training data set. In other words, fully connected layers may be conditioned on the category of object. This is shown in example Equation 4, where W_{c} represents the weights specific to the category c in the training dataset.

h_{c}=W_{c}·x (4)

In some embodiments, to introduce stochasticity, the output activations (e.g., h_{c} in Eq. (4)) obtained as a result of the inner product between the input x and weights W_{c} may act as parameters of a probability distribution. Any probability distribution is applicable according to the use case including Gaussian, Laplace, Binomial and Multinomial, etc. distributions. Instead of using W_{c} (as provided in Eq. (4)) directly as inputs to the next layers, the probability distribution may be sampled from to determine stochastic weights and the sample used to determine an input to the next layer.

Stochastic conditional noise layers may be useful for obfuscated training and inference for multiple applications including multi-class classification, multi-object detection, semantic and instance segmentation, multi-object tracking, etc. for image related task.

Multi-class image classification may encompass the task of categorizing an image into one class or category, when the training dataset contains multiple categories. In some embodiments, a given image may be obfuscated using conditional noise layers, such as stochastic conditional noise layers as described herein.

In some embodiments, to use stochastic conditional noise layers during model operation (e.g., inference, validation, etc.), when the category of images (labels) may not be known, selection layers may be used. Selection layers may be used to combine conditional layer that are designated for different labels. Each selection layer may consist of C tensors, if there are C total categories in the data set. In some embodiments, each of the C tensors is element-wise multiplied with the input x before being convolved with all the convolutional kernels. In some embodiments, the C tensors in the selection layer is element-wise multiplied with the output obtained when the input x is convolved with all the convolutional kernels. We elaborate the use of selection layer below, with respect to the first incarnation described above.

Hard selection layer. During training of stochastic noise layers, the label for each image x may be known. In such a case, a variant of the selection layer, called a hard selection layer may be used, where the C tensors have fixed values 0 or 1 depending on the image category. The values are 1 if the image matches the certain category. Otherwise, the values are 0. This may ensure that the given image of category c, only passes through kernels μ_{c} and σ_{c}, and no other sets of kernels, when x is element-wise multiplied with each tensor in the selection layer.

Soft selection layer. When the stochastic noise layers are fully trained using the hard selection layer described (such as as described above), the selection layer may be trainable. In some embodiments, the constraint of 0 or 1 on the pixel/feature values may be removed and the selection layer may have real pixel/feature values between 0 and 1, which may be called the soft selection layer. Each pixel/feature value may represent a probability that the particular region in the input is of interest for a category c. In some embodiments, the trained stochastic noise layers may be frozen and the parameters of the soft selection layer trained. In some embodiments, the stochastic layer and soft selection layer may be trained jointly. The trained soft selection layer may be used to combine the stochastic conditional layer during inference tasks, such as when the image category is not known.

Multi-Object detection may be the task of categorizing and localizing multiple objects, given an image. For example, objects of the categories “person” and “car” may be searched for (e.g., to be detected) in the input image. In some embodiments, a given image may be obfuscated using different embodiments of stochastic conditional noise layers

In some embodiments, to use stochastic conditional noise layers during inference or validation, when the category of objects in an images (labels) are not known, selection layers may be used. Selection layers may be used to combine the stochastic conditional layer that are designated for different labels. Each selection layer consists of C tensors of the same size as input x, if there are C total categories in the training data set. Each of the C tensors may be element-wise multiplied with the input x before being convolved with all the convolutional kernels. In some embodiments, hard or soft selection layers may be used.

Hard selection layer. During training of stochastic noise layers, the label for each object in the image x is known. In some embodiments, a hard selection layer may be used, where the C tensors have fixed pixel/feature values 0 or 1 depending on the object category of the image. The value is 1 if the object matches the certain category. Otherwise, the value is 0. This provides that the given object of category c, only passes through kernels μ_{c} and σ_{c}, and no other sets of kernels, when the input image x is element-wise multiplied with each tensor in the selection layer. The white pixels indicate the value of 1, and black pixels indicate the value of 0. This ensures that the regions of interests are retained when the input image x is element-wise multiplied with each tensor in the selection layer.

Soft selection layer. When the stochastic noise layers are fully trained using the hard selection layer, the selection layer may be trainable, and the constraint on the selection layer to have fixed values 0 or 1 may be removed (e.g., using a soft selection layer). The soft selection layer may have real values between 0 and 1. Each pixel/feature may represent a probability that the particular region is of interest for a certain category. In some embodiments, the trained stochastic noise layers may be frozen while the parameters of the soft selection layer are trained. In some embodiments, the stochastic layer and soft selection layer may be trained jointly. The trained soft selection layer may be used to combine the stochastic conditional layer during inference tasks, when the object categories are not known.

Stochastic conditional noise layers may be trained and used for inference. In a specific example, convolutional noise layers may be used, such as by assuming a gaussian distribution for the output activations for the task of multi-class classification. Other embodiments (e.g., types of distributions and applications) will have similar procedures for training and inference.

In some embodiments, training may be a two step procedure. In a first step, weights of the stochastic conditional layer may be learned. In a second step, the weights of the soft selection layers may be learned, which may be necessary during inference. Note that the training pipeline can be different depending on application. For example, step two (training of the weights of the soft selection layer) may be omitted if the user is aware of the class labels (such as during generation of an adversarial attack training layer). Hard selection layers may be used in that case. In some embodiments, a forward pass during the training procedure for the task of multi-class image classification.

In the specific example, prior to training, two sets of kernels (k_{μ}_{_{c}} and k_{σ}_{_{c}}) may be initialized for the two parameters, in a gaussian distribution, such as mean (μ_{c}) and standard deviation (σ_{c}) respectively, conditioned on each category c out of the total C categories in the training data set. During a forward pass, the kernels k_{μ}_{_{c}} and k_{σ}_{_{c}} may perform convolution operation on the input activation x, if x belongs to the category c. In other words, x is first multiplied with all the C tensors in the hard selection layer, π_{c}, which have values 1 if x belongs to category c, and 0 if x belongs to any other category. This modified input is then passed through the stochastic conditional layer. The output activation maps (μ_{c} and σ_{c}) may be obtained from the respective set of kernels according to example Equations 5 and 6, below, where μ_{c} and σ_{c} are mean and standard deviation, respectively, used to define the gaussian distribution.

$$\begin{matrix}{μ}_{c} [ m , n ] = ( x * {k}_{{μ}_{c}} ) [ m , n ] = {\sum }_{i} {\sum }_{j} {k}_{{μ}_{c}} [ i , j ] \times [ m + 1 , n + j ] & ( 5 ) \\ {σ}_{c} [ m , n ] = ( x * {k}_{{σ}_{c}} ) [ m , n ] = {\sum }_{i} {\sum }_{j} {k}_{{σ}_{c}} [ i , j ] \times [ m + 1 , n + j ] & ( 6 )\end{matrix}$$

In some embodiments an activation map h_{c} may be randomly sampled from this distribution, such as by according to Equation 7, below.

h_{c}˜N(μ_{c},σ_{c})⇒h_{c}=μ_{c}+σ_{c}ϵ;ϵ˜N(0,1) (7)

where h_{c} may act as an input activation for the next layers in the network.

In some embodiments, the kernels may be trained in a similar manner to standard convolutional neural networks. The parameters of the gaussian distribution for each category μ_{c} and σ_{c} (such as provided in Eqs. 5 and 6) may be obtained in the forward pass, and may be differentiable with respect to the kernels k_{μ}_{_{c}} and k_{σ}_{_{c}} respectively. h_{c} may be differentiable with respect to μ_{c} and σ_{c}. Gradients of the output activation h_{c} may be obtained with respect to the kernels k_{μ}_{_{c}} and k_{σ}_{_{c}}. The kernels k_{μ}_{_{c}} and k_{σ}_{_{c}} may be trainable using the aforementioned gradients through back-propagation and gradient descent (or other appropriate methods).

In some embodiments, the soft selection layer may be directly applied to the input x. The soft selection layer may be applied after the stochastic noise layers—or anywhere in the neural network.

An example training procedure for applying the selection layer directly to the input is described hereinafter. The input x may be multiplied with a trainable tensor of the soft selection layer π_{c} whose values are real and vary between 0 and 1, and which may represent the probability of the image belonging to a certain category c. If there are C categories in the dataset, there may be C tensors in the soft selection layer to be trained. π={π_{c}} may represent substantially all the tensors concatenated together. The modified input (x⊗π) may undergo a forward pass (e.g., through the model). The activations at every step may be differentiable with respect to the tensors in the soft selection layer and hence backpropagation and gradient descent may be directly applicable to train the soft selection layer.

In some embodiments, a step involving training of the soft selection layer may be omitted if the user is aware of the input category when the input is passed through the stochastic conditional layer. In that case, a hard selection layer, where π_{c}=1 if x belongs to category c, otherwise π_{c}=0 may be used.

In some embodiments, inference may be performed suing the conditional noise layers. Continuing the above, example, for inference the kernels k_{μ}_{_{c}} and k_{σ}_{_{c}} and tensors in the soft selection layer, π_{c}, may be trained (such as according to the previous description). A forward pass may be performed using the category masks and trained kernels to produce the a parameterized probability distribution, from which the output activation map h_{c} may be sampled. The output activation map may act as an input activation or the next layer in the neural network.

In some embodiments, incremental training of a neural network using data obfuscated by stochastic conditional noise layers (e.g., obfuscated before the data goes through the processing engine (CPU, GPU, TPU, etc.) for training) may be performed. The neural network may undergo incremental training (such as as described below) as more and more data becomes available. Since the labels of the training data may be known at the training time, stochastic conditional noise layers may be leveraged to create label-specific stochastic obfuscation for the model undergoing the training process or to generate adversarial attack information. The training procedure for the stochastic conditional noise layers in the incremental training setting may offer a knob to control the trade-offs between accuracy, obfuscation and availability of training data. An example of the incremental training procedure is discussed below, on the task of multi-class image classification. Any other task or embodiment is equally applicable, including multi-object detection, tracking, etc.

A given neural network may have very limited training data available. For example, only 5% of the entire training data set may be available to train the neural network. In this example, the neural network trained using the available training data (e.g., 5% of the training data) is referred to as NN-5.

NN-5 may be used to train a stochastic conditional layer, such as by using any appropriate method such as those described herein. The stochastic conditional layer may be referred to as SL-5. The stochastic conditional layer may be useful to obfuscate additional training data, so that the additional obfuscated training data may be used to further train the neural network. For example, the additional training data may be too sensitive to expose to untrusted actors, but may be available for training if it is obfuscated. SL-5 may also contain information about the robustness of NN-5. For example, the magnitude of SL-5 for various conditions c may provide information about the susceptibility of NN-5 to adversarial attack for each condition c.

SL-5 may be used to obfuscate the remaining 95% of the training data (which may involve regularization techniques described later). NN-5 may then be further trained using the 5% training data set and the 95% noisy data set, to generate an updated neural network (herein called NN′-5).

In some embodiments, more pure (e.g., non-noisy) training data may be made available, such as by iteration, until a desired accuracy (or other termination criteria) is reached.

In the example where 95% of the training data is obfuscated using a stochastic layer training on only 5% of the pure training dataset (SL-5), the noisy data coming from the stochastic layer may be highly biased towards the small ratio of the data SL-5 was trained on. To reduce this bias, a regularization step may be performed where randomly selected parts of the noisy data are screened at every iteration of the training, so that the screened parts aren't visible to the neural network.

Federated learning may concern itself with using multiple isolated machines (entities) to train a global model without sharing the private data on each machine. Some embodiments are focused on obfuscating each individual data record during training in each private machine (entity). Therefore, in some embodiments of the stochastic conditional layer involves combination with federated learning as a complementary and orthogonal procedure to federated learning for additional privacy measures. The stochastic conditional layer may be integrated with federated learning and incremental training, while aiming to obfuscate information from the data records before they go through the processing engine (CPU, GPU, TPU, etc.) in each isolated machine.

In an example, consider a neural network N, a stochastic conditional layer SL, and n additional regular layers L_{i(i=1 to n)}. When using N without the stochastic conditional layer, the input is applied to N and the output is provided without the involvement of S_{L} or Lᵢ. In some embodiments, the input x is provided to regularization layers and then the conditional noise layer, such as x→L_{i(i=1 to n)}→S_{L}→N.

In some embodiments, N may be made up of two parts, e.g., N₁ and N₂, such as where N may be equivalent to N₁, N₂ back to back. In some embodiments, input x may be provided to the first part of N to generate an intermediate output, given by O₁=x→N₁. Another intermediate output may be determined by applying the regularization layers to x, such that O₂=X→L_{i(i=1 to n)} The intermediate outputs may then be merged and the results passed through the conditional noise layer S_{L} and the resulting activation provided to N₂.

In some embodiments, S_{L} may be applied to O₂, then results merged with O₁, and results of the merge passed through N₂.

Reference to “minimums” and “maximums” should not be read as limited to finding these values with absolute precision and includes approximating these values within ranges that are suitable for the use case and adopted by practitioners in the field. It is generally not feasible to compute “minimums” or “maximums” to an infinite number of significant digits and spurious claim construction arguments to this effect should be rejected.

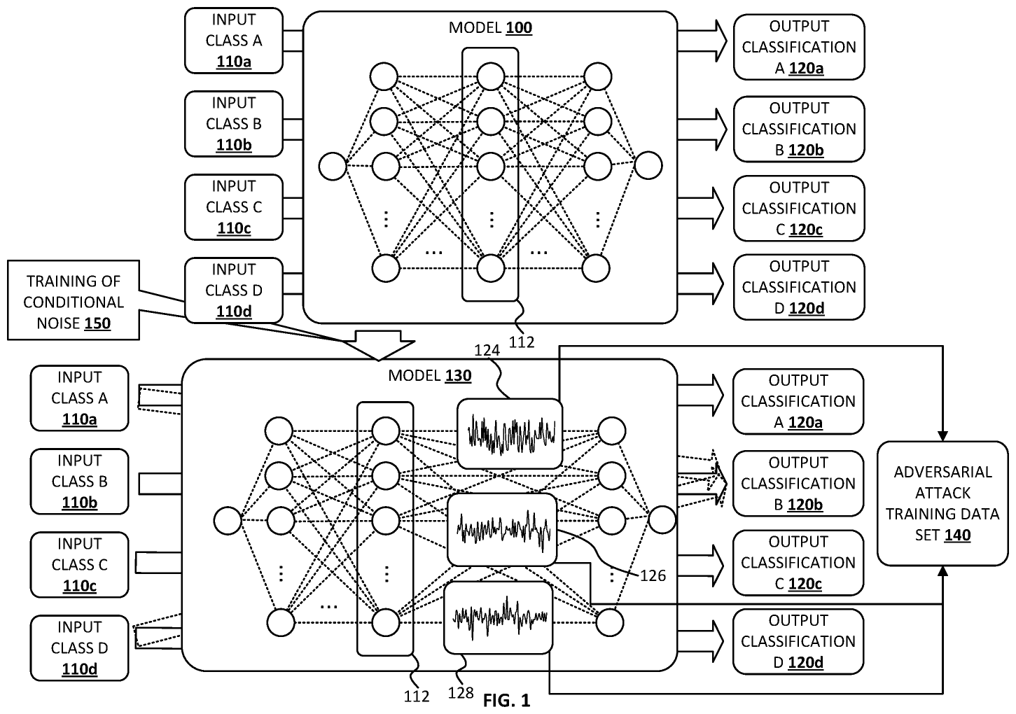

The forgoing embodiments may be implemented in connection with example systems and techniques depicted in FIGS. 1-8. It should be emphasized, though, that the figures depict certain embodiments and should not be read as limiting.

FIG. 1 depicts an example machine learning model 130 using conditional noise layers. FIG. 1 depicts an example machine learning model 100, trained to determine output classifications A-D (e.g., output classification A 120a, output classification B 120b, output classification C 120c, and output classification D 120d). Each output classification 120a-120d corresponds to a set of input data, having a corresponding one of input class a 110a, input class b 110b, input class c 110c, and input class d 110d. An example machine learning model with conditional noise 130 may be generated from the machine learning model 100 and training of the conditional noise 150. The conditional noise, as represented by stochastic sampling 124, 126, 128, may be added to the model 130 at any appropriate node or weight, using any appropriate process. The conditional noise may be trained to produce the maximum noise (e.g., magnitude) which allows for mapping of the input class to output classification, to within an accuracy threshold. The conditional noise may be trained to produce the minimum noise (e.g., magnitude) which prevents mapping of the input class to a respective output classification, to within an accuracy threshold. The trained conditional noise, which may vary for each condition c, may be used to generate an adversarial attack training data set 140 or a universal adversarial examples. The adversarial attack training data set 140 may be used to further train a model (such as the model 100) against adversarial attack. The adversarial attack training data set 140 may be used to generate a patch which may make data difficult to classify, to within a threshold.

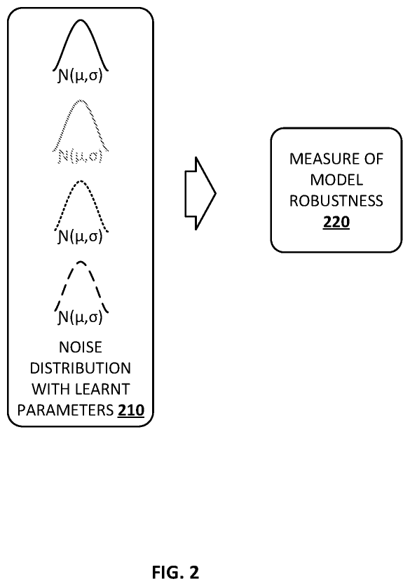

FIG. 2 depicts an example measure of model robustness 220, determined using conditional nosie layers. The measure of model robustness 220 may be determined based on noise distributions with learnt parameters 210. Each of the conditional noise layers (or selection layers) may have one or more noise distributions—including multiple noise distributions which are applied to different parts of the data. The learnt noise distribution for each conditional noise layer may provide information about the robustness of the model for a given condition c. In the following example, conditional noise layers trained to identify a maximum noise for which the model correctly identifies data is assumed. For example, a conditional noise layer with a large standard deviation may indicate that the model is robust to small noisy spikes in data, while a conditional noise layer with a large magnitude may indicate that the model is robust to noisy data. A conditional noise layer with a small magnitude may indicate that a model may be relatively easily biased by noisy input data to incorrectly label input data. The measure of model robustness 220 may be different for each conditional noise layer. The measure of model robustness may be different for each location of input noise, e.g., for noise input at different layers in the model.

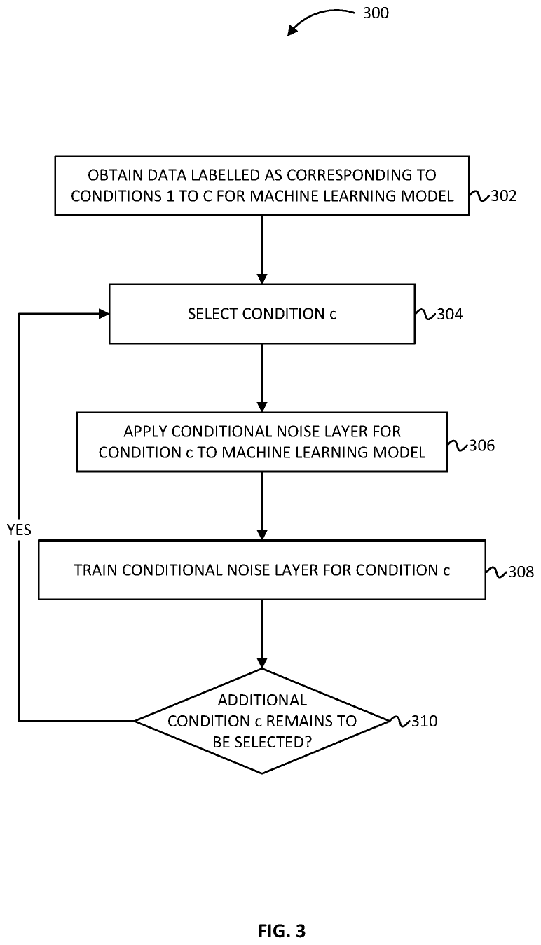

FIG. 3 illustrates an exemplary method 300 for conditional noise layer training. Each of these operations is described in detail below. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting. In some embodiments, one or more portions of method 300 may be implemented (e.g., by simulation, modeling, etc.) in one or more processing devices (e.g., one or more processors). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300, for example. For illustrative purposes, optional operations are depicted with dashed lines. However, operations which are shown with unbroken lines may also be optional or may be omitted.

At an operation 302, labeled data is obtained. The labeled data may be training data. The data may be labeled as corresponding to a condition c, where the condition c is one of any conditions 1 to C. The labeled data may correspond to a machine learning model. The machine learning model may be trained, such as based on the labeled data, or obtained as a trained model. The machine learning model may be any appropriate machine learning model. The training data may be unlabeled, semi-labeled, etc. in some embodiments, including where a trained machine learning model is provided, if the machine learning model is an autoencoder, etc.

At an operation 304, a condition c of the conditions 1 to C is selected. The condition c may be a label, class of labels, etc. of the training data. The condition c may be selected from the conditions 1 to C which have not yet had a conditional noise layer trained.

At an operation 306, a conditional noise layer for condition c is applied to the machine learning model. The conditional noise layer may be applied to any appropriate location within the machine learning model. The conditional noise layer may be made up of multiple selection layers. The conditional noise layer may be applied to the input before the input is acted on by the machine learning model. The conditional noise layer may be applied to one or more of multiple machine learning models, such as to one machine learning model is a federated machine learning model system.

At an operation 308, the noise layer is trained for condition c. The conditional noise layer may correspond to multiple conditions (such as c and c′) and be trained independently for the multiple conditions, trained for each condition sequentially, trained for the multiple conditions at once, etc. The conditional noise layer may be trained using an optimization function. The conditional noise layer may be trained as a maximum (e.g., in magnitude, dispersion, measure of central tendency), a minimum, etc. The conditional noise layer may be stochastic. The conditional noise layer may be sampled from one or more distribution, such as a Gaussian. The noise layer may be trained to correctly identify the condition c. The noise layer may be trained to incorrectly identify the condition c, including driving data corresponding to the condition c to an incorrect condition c′.

At an operation 310, it may be determined if an additional condition c remains to be selected for training of a conditional noise layer. If an additional condition c remains, flow continues to the operation 304 where another condition is selected for training of a conditional noise layer.

Examples of noise distributions and stochastic gradient methods that may be used to find minimum or maximum perturbations are described in U.S. Provisional Pat. App. 63/227,846, titled STOCHASTIC LAYERS, filed 30 Jul. 2021 (describing examples of stochastic layers with properties like those relevant here); U.S. Provisional Pat. App. 63/221,738, titled REMOTELY-MANAGED, NEAR-STORAGE OR NEAR-MEMORY DATA TRANSFORMATIONS, filed 14 Jul. 2021 (describing data transformations that may be used with the present techniques, e.g., on training data); and U.S. Provisional Pat. App. 63/153,284, titled METHODS AND SYSTEMS FOR SPECIALIZING DATASETS FOR TRAINING/VALIDATION OF MACHINE LEARNING, filed 24 Feb. 2021 (describing examples of obfuscation techniques that may be used with the present techniques); each of which is hereby incorporated by reference.

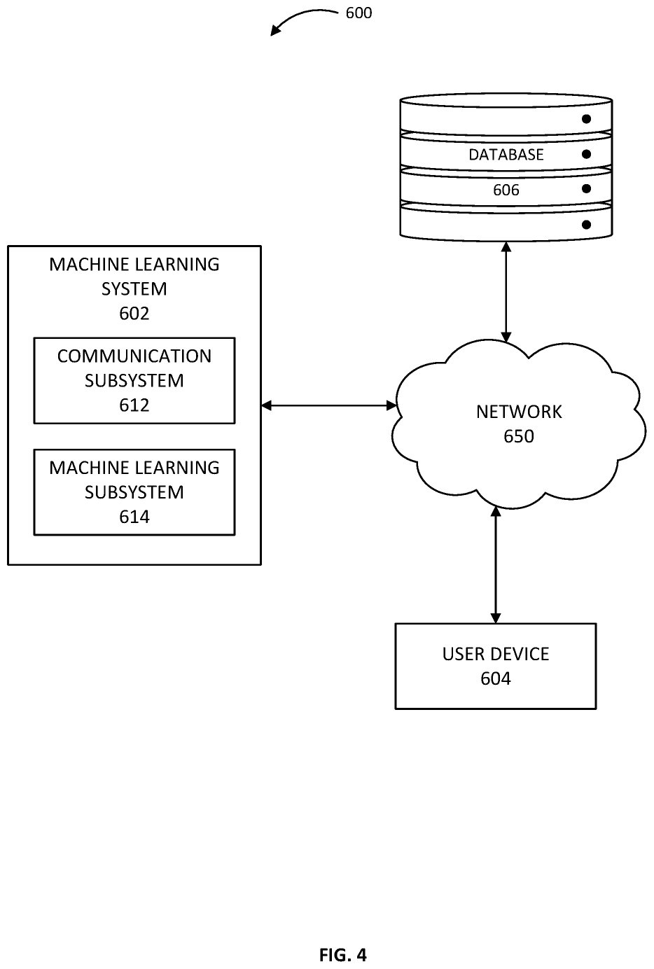

FIG. 4 shows an example computing system 600 for implementing data obfuscation in machine learning models. The computing system 600 may include a machine learning (ML) system 602, a user device 604, and a database 606. The ML system 602 may include a communication subsystem 612, and a machine learning (ML) subsystem 614. The communication subsystem 612 may retrieve one or more datasets from the database 606 for use in training or performing inference via the ML subsystem 614 (e.g., using one or more machine-learning models described in connection with FIG. 4).

One or more machine learning models used (e.g., for training or inference) by the ML subsystem 614 may include one or more conditional noise layers. A conditional noise layer may receive input from a previous layer (e.g., in a neural network or other machine learning model) and output data to subsequent layers, for example, in a forward pass of a machine learning model. A conditional noise layer may take first data as input and perform one or more operations on the first data to generate second data. For example, the conditional noise layer may be a stochastic convolutional layer with a first filter that corresponds to the mean of a normal distribution and a second filter that corresponds to the standard deviation of the normal distribution. The second data may be used as parameters of a distribution (e.g. or may be used to define parameters of a distribution). For example, the second data may include data (e.g., data indicating the mean of the normal distribution) that is generated by convolving the first filter over an input image. In this example, the second data may include data (e.g., data indicating the standard deviation of the normal distribution) that is generated by convolving the second filter over the input image.

One or more values may be sampled from the distribution. The one or more values may be used as input to a subsequent layer (e.g., the next layer following the stochastic layer in a neural network). For example, the mean generated via the first filter and the standard deviation generated via the second filter (e.g., as discussed above) may be used to sample one or more values. The one or more values may be used as input into a subsequent layer. The subsequent layer may be a stochastic layer (e.g., a stochastic convolution layer, stochastic fully connected layer, stochastic activation layer, stochastic pooling layer, stochastic batch normalization layer, stochastic embedding layer, or a variety of other stochastic layers) or a non-stochastic layer (e.g., convolution, fully-connected, activation, pooling, batch normalization, embedding, or a variety of other layers).

A conditional noise layer or one or more parameters of a stochastic layer may be trained via gradient descent (e.g., stochastic gradient descent) and backpropagation, or a variety of other training methods. One or more parameters may be trained, for example, because the one or more parameters are differentiable with respect to one or more other parameters of the machine learning model. For example, the mean of the normal distribution may be differentiable with respect to the first filter (e.g., or vice versa). As an additional example, the standard deviation may be differentiable with respect to the second filter (e.g., or vice versa).

In some embodiments, one or more parameters of a conditional noise layer may be represented by a probability distribution. For example, a filter in a stochastic convolution layer may be represented by a probability distribution. The ML subsystem 614 may generate a parameter (e.g., a filter or any other parameter) of a stochastic layer by sampling from a corresponding probability distribution.

In some embodiments, the system determines a maximum noise variance causing a minimum reconstruction loss on the neural network. The maximum noise variance is a differentiable output. To obtain the maximum noise variance value, the system calculates gradients using gradient descent algorithms (e.g., stochastic gradient descent) on a pre-trained neural network. As the neural network is pre-trained with known weight parameters, the optimization calculates the gradients with respect to the minimum noise variance (e.g., perturbations).

In some embodiments, the maximum noise variance may be determined as described herein and applied to one or more intermediate layers of a machine learning model.

In some embodiments, the maximum noise variance may be constrained by a maximum reconstruction loss value. The maximum reconstruction loss value may depend on the type of model as a subsequent machine learning model which is to be trained on the obfuscated data. The maximum reconstruction loss value may be variable.

The user device 604 may be a variety of different types of computing devices, including, but not limited to (which is not to suggest that other lists are limiting), a laptop computer, a tablet computer, a hand-held computer, smartphone, other computer equipment (e.g., a server or virtual server), including “smart,” wireless, wearable, Internet of Things device, or mobile devices. The user device 604 may be any device used by a healthcare professional (e.g., a mobile phone, a desktop computer used by healthcare professionals at a medical facility, etc.). The user device 604 may send commands to the ML system 602 (e.g., to train a machine-learning model, perform inference, etc.). Although only one user device 604 is shown, the system 600 may include any number of client devices.

The ML system 602 may include one or more computing devices described above and may include any type of mobile terminal, fixed terminal, or other device. For example, the ML system 602 may be implemented as a cloud computing system and may feature one or more component devices. Users may, for example, utilize one or more other devices to interact with devices, one or more servers, or other components of system 600. In some embodiments, operations described herein as being performed by particular components of the system 600, may be performed by other components of the system 600 (which is not to suggest that other features are not also amenable to variation). As an example, while one or more operations are described herein as being performed by components of the ML system 602, those operations may be performed by components of the user device 604 or database 606. In some embodiments, the various computers and systems described herein may include one or more computing devices that are programmed to perform the described functions. In some embodiments, multiple users may interact with system 600. For example, a first user and a second user may interact with the ML system 602 using two different user devices.

One or more components of the ML system 602, user device 604, and database 606, may receive content and other data via input/output (hereinafter “I/O”) paths. The one or more components of the ML system 602, the user device 604, and/or the database 606 may include processors and/or control circuitry to send and receive commands, requests, and other suitable data using the I/O paths. The control circuitry may include any suitable processing, storage, and/or input/output circuitry. Each of these devices may include a user input interface and/or user output interface (e.g., a display) for use in receiving and displaying data. It should be noted that in some embodiments, the ML system 602, the user device 604, and the database 606 may have neither user input interface nor displays and may instead receive and display content using another device (e.g., a dedicated display device such as a computer screen and/or a dedicated input device such as a remote control, mouse, voice input, etc.). Additionally, the devices in system 600 may run an application (or another suitable program). The application may cause the processors and other control circuitry to perform operations related to weighting training data (e.g., to increase the efficiency of training and performance of one or more machine-learning models described herein).

One or more components or devices in the system 600 may include electronic storages. The electronic storages may include non-transitory storage media that electronically stores information. The electronic storage media of the electronic storages may include one or both of (a) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), or other electronically, magnetically, or optically readable storage media. The electronic storages may include one or more virtual storage resources (e.g., cloud storage, a virtual private network, or other virtual storage resources). The electronic storages may store software algorithms, information determined by the processors, information obtained from servers, information obtained from client devices, or other information that enables the functionality as described herein.

FIG. 4 also includes a network 650. The network 650 may be the Internet, a mobile phone network, a mobile voice or data network (e.g., a 5G or LTE network), a cable network, a public switched telephone network, a combination of these networks, or other types of communications networks or combinations of communications networks. The devices in FIG. 4 (e.g., ML system 602, the user device 604, and/or the database 606) may communicate (e.g., with each other or other computing systems not shown in FIG. 4) via the network 650 using one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The devices in FIG. 4 may include additional communication paths linking hardware, software, and/or firmware components operating together. For example, the ML system 602, any component of the ML system 602 (e.g., the communication subsystem 612 or the ML subsystem 614), the user device 604, and/or the database 606 may be implemented by one or more computing platforms.

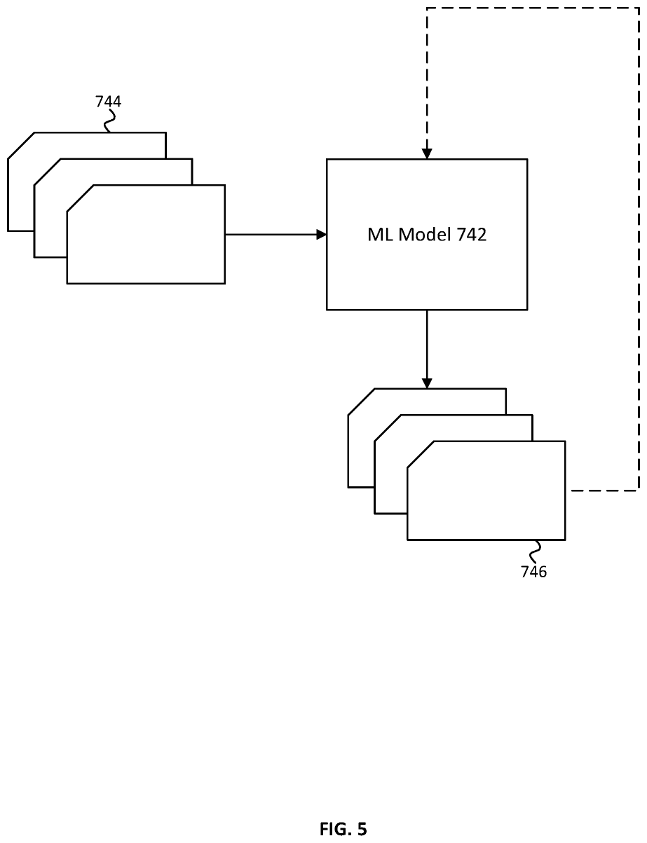

One or more machine-learning models that are discussed above (e.g., in connection with FIG. 4) may be implemented, for example, as shown in FIG. 5. With respect to FIG. 5, machine-learning model 742 may take inputs 744 and provide outputs 746.

In some use cases, outputs 746 may be fed back to machine-learning model 742 as input to train machine-learning model 742 (e.g., alone or in conjunction with user indications of the accuracy of outputs 746, labels associated with the inputs, or with other reference feedback and/or performance metric information). In another use case, machine-learning model 742 may update its configurations (e.g., weights, biases, or other parameters) based on its assessment of its prediction (e.g., outputs 746) and reference feedback information (e.g., user indication of accuracy, reference labels, or other information). In another example use case, where machine-learning model 742 is a neural network and connection weights may be adjusted to reconcile differences between the neural network's output and the reference feedback. In some use cases, one or more perceptrons (or nodes) of the neural network may require that their respective errors are sent backward through the neural network to them to facilitate the update process (e.g., backpropagation of error). Updates to the connection weights may, for example, be reflective of the magnitude of error propagated backward after a forward pass has been completed. In this way, for example, the machine-learning model 742 may be trained to generate results (e.g., response time predictions, sentiment identifiers, urgency levels, etc.) with better recall, accuracy, or precision.

In some embodiments, the machine-learning model 742 may include an artificial neural network (“neural network” herein for short). In such embodiments, machine-learning model 742 may include an input layer (e.g., a conditional noise layer as described in connection with FIG. 4) and one or more hidden layers (e.g., a conditional noise layer as described in connection with FIG. 4). Each neural unit of the machine-learning model may be connected with one or more other neural units of the machine-learning model 742. Such connections may be enforcing or inhibitory in their effect on the activation state of connected neural units. Each individual neural unit may have a summation function which combines the values of one or more of its inputs together. Each connection (or the neural unit itself) may have a threshold function that a signal must surpass before it propagates to other neural units. The machine-learning model 742 may be self-learning (e.g., trained), rather than explicitly programmed, and may perform significantly better in certain areas of problem solving, as compared to computer programs that do not use machine learning. During training, an output layer (e.g., a conditional noise layer as described in connection with FIG. 4) of the machine-learning model 742 may correspond to a classification, and an input (e.g., any of the data or features described in the machine learning specification above) known to correspond to that classification may be input into an input layer of machine-learning model during training. During testing, an input without a known classification may be input into the input layer, and a determined classification may be output. The machine-learning model 742 trained by the ML subsystem 614 may include one or more embedding layers (e.g., a conditional noise layer as described in connection with FIG. 4) at which information or data (e.g., any data or information discussed above in connection with the machine learning specification) is converted into one or more vector representations. The one or more vector representations of the message may be pooled at one or more subsequent layers (e.g., a conditional noise layer as described in connection with FIG. 4) to convert the one or more vector representations into a single vector representation.

The machine-learning model 742 may be structured as a factorization machine model. The machine-learning model 742 may be a non-linear model and/or (use of which should not be read to suggest that other uses of “or” mean “xor”) supervised learning model that may perform classification and/or regression. For example, the machine-learning model 742 may be a general-purpose supervised learning algorithm that the system uses for both classification and regression tasks. Alternatively, the machine-learning model 742 may include a Bayesian model configured to perform variational inference given any of the inputs 744. The machine-learning model 742 may be implemented as a decision tree, as an ensemble model (e.g., using random forest, bagging, adaptive booster, gradient boost, XGBoost, etc.), or any other machine-learning model.

The machine-learning model 742 may be a reinforcement learning model. The machine-learning model 742 may take as input any of the features described above (e.g., in connection with the machine learning specification) and may output a recommended action to perform. The machine-learning model may implement a reinforcement learning policy that includes a set of actions, a set of rewards, and/or a state.

The reinforcement learning policy may include a reward set (e.g., value set) that indicates the rewards that the machine-learning model obtains (e.g., as the result of the sequence of multiple actions). The reinforcement learning policy may include a state that indicates the environment or state that the machine-learning model is operating in. The machine-learning model may output a selection of an action based on the current state and/or previous states. The state may be updated at a predetermined frequency (e.g., every second, every 2 hours, or a variety of other frequencies). The machine-learning model may output an action in response to each update of the state. For example, if the state is updated at the beginning of each day, the machine-learning model 742 may output an action to take based on the action set and/or one or more weights that have been trained/adjusted in the machine-learning model 742. The state may include any of the features described in connection with the machine learning specification above. The machine-learning model 742 may include a Q-learning network (e.g., a deep Q-learning network) that implements the reinforcement learning policy described above.

In some embodiments, the machine-learning models may include a Bayesian network, such as a dynamic Bayesian network trained with Baum-Welch or the Viterbi algorithm. Other models may also be used to account for the acquisition of information over time to predict future events, e.g., various recurrent neural networks, like long-short-term memory models trained on gradient descent after loop unrolling, reinforcement learning models, and time-series transformer architectures with multi-headed attention. In some embodiments, some or all of the weights or coefficients of models described herein may be calculated by executing a machine learning algorithm on a training set of historical data. Some embodiments may execute a gradient descent optimization to determine model parameter values. Some embodiments may construct the model by, for example, assigning randomly selected weights; calculating an error amount with which the model describes the historical data and a rate of change in that error as a function of the weights in the model in the vicinity of the current weight (e.g., a derivative, or local slope); and incrementing the weights in a downward (or error reducing) direction. In some cases, these steps may be iteratively repeated until a change in error between iterations is less than a threshold amount, indicating at least a local minimum, if not a global minimum. To mitigate the risk of local minima, some embodiments may repeat the gradient descent optimization with multiple initial random values to confirm that iterations converge on a likely global minimum error. Other embodiments may iteratively adjust other machine learning models to reduce the error function, e.g., with a greedy algorithm that optimizes for the current iteration. The resulting, trained model, e.g., a vector of weights or thresholds, may be stored in memory and later retrieved for application to new calculations on newly calculated aggregate estimates.

In some cases, the amount of training data may be relatively sparse. This may make certain models less suitable than others. In such cases, some embodiments may use a triplet loss network or Siamese networks to compute similarity between out-of-sample records and example records in a training set, e.g., determining based on cosine distance, Manhattan distance, or Euclidian distance of corresponding vectors in an encoding space (e.g., with more than 5 dimensions, such as more than 50).

Run time may process inputs outside of a training set and may be different from training time, except for in use cases like active learning. Random selection includes pseudorandom selections. In some cases, the neural network may be relatively large, and the portion that is non-deterministic may be a relatively small portion. The neural network may have more than 10, 50, or 500 layers, and the number of stochastic layers may be less than 10, 5, or 3, in some cases. In some cases, the number of parameters of the neural network may be greater than 10,000; 100,000; 1,000,000; or 10,000,000; while the number of stochastic parameters may be less than 10%, 5%, 1%, or 0.1% of that. This is expected to address problems that arise when traditional probabilistic neural networks attempt to scale, which with many approaches, produces undesirably excessive scaling in memory or run time complexity. Other benefits expected of some embodiments include enhanced interpretability of trained neural networks based on statistical parameters of trained stochastic layers, the values of which may provide insight (e.g., through visualization, like by color coding layers or components thereof according to values of statistical parameters after training) into the contribution of various features in outputs of the neural network, enhanced privacy from injecting noise with granularity into select features or layers of the neural network making downstream layers our outputs less likely to leak information, and highlighting layers or portions thereof for pruning to compress neural networks without excessively impairing performance by removing those components that the statistical parameters indicate are not contributing sufficiently to performance. In some cases, the stochastic layers may be partially or fully constituted of differential parameters adjusted during training, which is expected to afford substantial benefits in terms of computational complexity during training relative to models with non-differentiable parameters. That said, embodiments are not limited to systems affording all of these benefits, which is not to suggest that any other description is limiting.

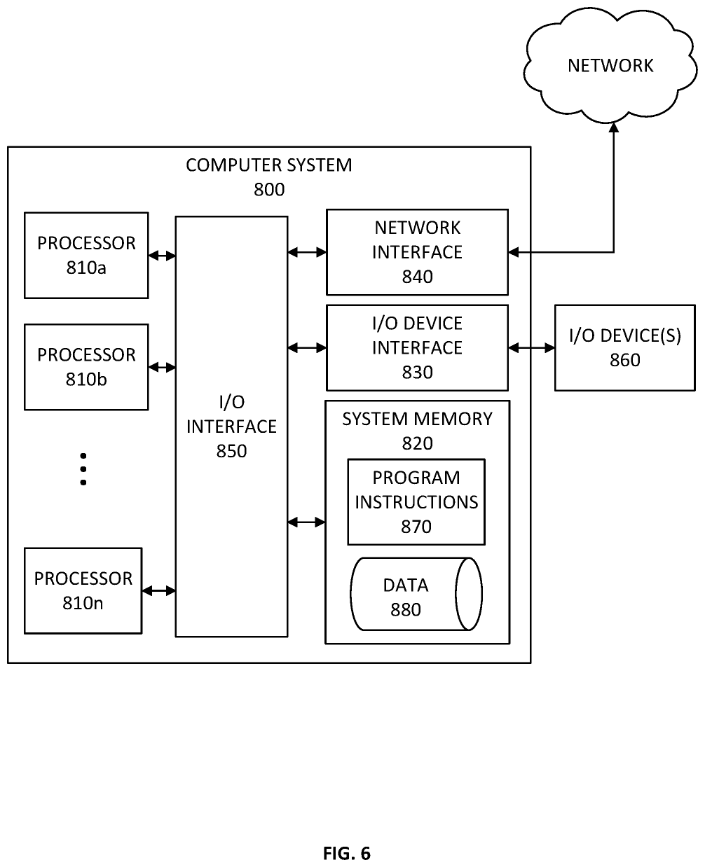

FIG. 6 is a diagram that illustrates an exemplary computing system 800 in accordance with embodiments of the present technique. Various portions of systems and methods described herein, may include or be executed on one or more computer systems similar to computing system 800. Further, processes and modules described herein may be executed by one or more processing systems similar to that of computing system 800.

Computing system 800 may include one or more processors (e.g., processors 810a-810n) coupled to system memory 820, an input/output I/O device interface 830, and a network interface 840 via an input/output (I/O) interface 850. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 800. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 820). Computing system 800 may be a units-processor system including one processor (e.g., processor 810a), or a multi-processor system including any number of suitable processors (e.g., 810a-810n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 800 may include a plurality of computing devices (e.g., distributed computer systems) to implement various processing functions.

I/O device interface 830 may provide an interface for connection of one or more I/O devices 860 to computing system 800. I/O devices may include devices that receive input (e.g., from a user) or output information (e.g., to a user). I/O devices 860 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 860 may be connected to computing system 800 through a wired or wireless connection. I/O devices 860 may be connected to computing system 800 from a remote location. I/O devices 860 located on remote computer system, for example, may be connected to computing system 800 via a network and network interface 840.

Network interface 840 may include a network adapter that provides for connection of computing system 800 to a network. Network interface 840 may facilitate data exchange between computing system 800 and other devices connected to the network. Network interface 840 may support wired or wireless communication. The network may include an electronic communication network, such as the Internet, a local area network (LAN), a wide area network (WAN), a cellular communications network, or the like.

System memory 820 may be configured to store program instructions 870 or data 880. Program instructions 870 may be executable by a processor (e.g., one or more of processors 810a-810n) to implement one or more embodiments of the present techniques. Instructions 870 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 820 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random-access memory (SRAM), synchronous dynamic RAM (SDRAM)), bulk storage memory (e.g., CD-ROM and/or DVD-ROM, hard-drives), or the like. System memory 820 may include a non-transitory computer readable storage medium that may have program instructions stored thereon that are executable by a computer processor (e.g., one or more of processors 810a-810n) to cause the subject matter and the functional operations described herein. A memory (e.g., system memory 820) may include a single memory device and/or a plurality of memory devices (e.g., distributed memory devices).

I/O interface 850 may be configured to coordinate I/O traffic between processors 810a-810n, system memory 820, network interface 840, I/O devices 860, and/or other peripheral devices. I/O interface 850 may perform protocol, timing, or other data transformations to convert data signals from one component (e.g., system memory 820) into a format suitable for use by another component (e.g., processors 810a-810n). I/O interface 850 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 800 or multiple computer systems 800 configured to host different portions or instances of embodiments. Multiple computer systems 800 may provide for parallel or sequential processing/execution of one or more portions of the techniques described herein.

Those skilled in the art will appreciate that computing system 800 is merely illustrative and is not intended to limit the scope of the techniques described herein. Computing system 800 may include any combination of devices or software that may perform or otherwise provide for the performance of the techniques described herein. For example, computing system 800 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computing system 800 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 800 may be transmitted to computing system 800 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present disclosure may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine-readable medium. In some cases, third party content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several disclosures. Rather than separating those disclosures into multiple isolated patent applications, applicants have grouped these disclosures into a single document because their related subject matter lends itself to economies in the application process. But the distinct advantages and aspects of such disclosures should not be conflated. In some cases, embodiments address all of the deficiencies noted herein, but it should be understood that the disclosures are independently useful, and some embodiments address only a subset of such problems or offer other, unmentioned benefits that will be apparent to those of skill in the art reviewing the present disclosure. Due to costs constraints, some features disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such disclosures or all aspects of such disclosures.

It should be understood that the description and the drawings are not intended to limit the disclosure to the particular form disclosed, but to the contrary, the intention is to cover all modifications, equivalents, and alternatives falling within the spirit and scope of the present disclosure as defined by the appended claims. Further modifications and alternative embodiments of various aspects of the disclosure will be apparent to those skilled in the art in view of this description. Accordingly, this description and the drawings are to be construed as illustrative only and are for the purpose of teaching those skilled in the art the general manner of carrying out the disclosure. It is to be understood that the forms of the disclosure shown and described herein are to be taken as examples of embodiments. Elements and materials may be substituted for those illustrated and described herein, parts and processes may be reversed or omitted, and certain features of the disclosure may be utilized independently, all as would be apparent to one skilled in the art after having the benefit of this description of the disclosure. Changes may be made in the elements described herein without departing from the spirit and scope of the disclosure as described in the following claims. Headings used herein are for organizational purposes only and are not meant to be used to limit the scope of the description.

As used throughout this application, the word “may” is used in a permissive sense (e.g., meaning having the potential to), rather than the mandatory sense (e.g., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, e.g., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing actions A, B, C, and D) encompasses both all such attributes or functions being mapped to all such objects and subsets of the attributes or functions being mapped to subsets of the attributes or functions (e.g., both all processors each performing actions A-D, and a case in which processor 1 performs action A, processor 2 performs action B and part of action C, and processor 3 performs part of action C and action D), unless otherwise indicated. Further, unless otherwise indicated, statements that one value or action is “based on” another condition or value encompass both instances in which the condition or value is the sole factor and instances in which the condition or value is one factor among a plurality of factors. The term “each” is not limited to “each and every” unless indicated otherwise. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

In this patent filing, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

1. A non-transitory computer-readable storage medium storing instructions that when executed by one or more processors perform operations comprising:
obtaining, with a computer system, a data set having labeled members with labels designating corresponding members as belonging to corresponding classes;
training, with the computer system, a machine learning model having deterministic layers and a parallel set of conditional layers each corresponding to a different class among the corresponding classes, wherein training includes adjusting parameters of the machine learning model according to an objective function that is differentiable; and
storing, with the computer system, the trained machine learning model in memory.

2. The medium of claim 1, wherein the parallel set of conditional layers are stochastic layers and wherein training includes learning, for at least one parameter in each of the parallel set of stochastic layers, a corresponding distribution to be randomly sampled from during operation of the machine learning model.

3. The medium of claim 2, wherein:
the respective distributions are parametric statistical distributions, each characterized, at least in part, by a respective pair of statistical parameters; and
the operations further comprise learning, using gradient descent, for each of the respective distributions, the respective pairs of statistical parameters based on an objective function, wherein the objective function is differentiable with respect to the respective pairs of statistical parameters of the respective probability distributions.

4. The medium of claim 1, wherein the machine learning model further comprises a selection layer configured to select among the parallel set of layers based on a class of input data.

5. The medium of claim 1, further comprising determining a measure of robustness of the machine learning model based on the trained parallel set of conditional layers.

6. The medium of claim 5, wherein determining the measure of robustness comprises determining a magnitude based on the trained parallel set of conditional layers.

7. The medium of claim 5, wherein determining a measure of robustness of the machine learning model comprises determining a measure of robustness for a given condition corresponding to a give of the parallel set of conditional layers.

8. The medium of claim 1, the operations further comprising determining an adversarial example based on a given of the parallel set of conditional layers.

9. The medium of claim 1, the operations further comprising generating a set of adversarial attack training data based on the parallel set of conditional layers.

10. The medium of claim 9, the operations further comprising additionally training the machine learning model based on the set of adversarial attack training data.

11. The medium of claim 1, wherein training according to the objective function includes adjusting parameters of the machine learning model to maximize noise in the parallel set of conditional layers while minimizing loss in the model.

12. The medium of claim 1, wherein training according to the objective function includes adjusting parameters of the machine learning model to minimize noise in the parallel set of conditional layers while maximizing accuracy of the model.

13. The medium of claim 1, wherein the operations comprise steps for learning distributions of the parallel set of conditional layers.

14. The medium of claim 1, wherein the operations comprise steps for applying the parallel set of conditional layers to the machine learning model.

15. The medium of claim 1, wherein the parallel set of conditional layers are convolutional layers.

16. The medium of claim 1, wherein at least some of the labeled members of the training set are obfuscated during training.

17. The medium of claim 1, further comprising obfuscating data based on the trained machine learning model.

18. The medium of claim 1, wherein the machine learning model further comprises a regularization layer.

19. The medium of claim 1, wherein the machine learning model is a neural network.

20. A method comprising:
obtaining, with a computer system, a data set having labeled members with labels designating corresponding members as belonging to corresponding classes;
training, with the computer system, a machine learning model having deterministic layers and a parallel set of conditional layers each corresponding to a different class among the corresponding classes, wherein training includes adjusting parameters of the machine learning model according to an objective function that is differentiable; and
storing, with the computer system, the trained machine learning model in memory.
